(19) United States
(12) Patent Application Publication
(10) Pub. No.: US 2024/0278727 A1
(43) Pub. Date: Aug. 22, 2024

(54) PADDED ENDCAP DEVICE

(71) Applicants: David Robert Kracke, Portland, OR (US); Robert William DeLorenzo, Hermosa Beach, CA (US)

(72) Inventors: David Robert Kracke, Portland, OR (US); Robert William DeLorenzo, Hermosa Beach, CA (US)

(21) Appl. No.: 18/584,613

(22) Filed: Feb. 22, 2024

Related U.S. Application Data
(60) Provisional application No. 63/576,684, filed on Feb. 22, 2023.

(51) Int. Cl. B60R 9/052

(52) U.S. Cl. CPC B60R 9/052

(57) ABSTRACT

An endcap for a roof rack crossbar including a main body and a clamp configured to secure the main body to the crossbar. The main body includes a padding material that substantially covers a lower surface of the main body, and a channel to receive an end portion of the crossbar. An actuator of the clamp is accessible from above the main body.

### CROSS-REFERENCE TO RELATED APPLICATIONS

This application claims the benefit under 35 U.S.C. § 119(e) of the priority of U.S. Provisional Patent Application Ser. No. 63/576,684, filed Feb. 22, 2023, the entirety of which is hereby incorporated by reference for all purposes.

### BACKGROUND OF THE INVENTION

Vehicle roof racks have become specialized and technologically advanced to accommodate not only most all types of automobiles, SUVs, pick-up trucks, and the like, but also to provide a wide variety of roof rack attachments to allow for the secure attachment of many different devices, boxes, bicycle holders, watercraft holders, ski and snowboard holders, and many others. These racks include two or more bars that are mounted perpendicular to the front/back axis of the vehicle, and often referred to as crossbars. Occasionally, in order to accommodate certain items, the crossbars will extend beyond the side edges of the vehicle. The ends of the crossbars may be thereby positioned such that they can cause a person in close proximity to the vehicle to hit their head on the extending portion of the crossbar(s). An impact between a person's head and the un-padded, protruding ends of the roof rack crossbars can be painful, and even lead to serious head injury.

Therefore, a device is desirable that provides protective padding on the ends of crossbars that extend over the edge(s) of a vehicle to eliminate, or significantly reduce, the risk of injury if a person hits their head on the portion of the bar that extends over the edge of the vehicle.

### SUMMARY OF THE INVENTION

The present disclosure provides systems, apparatus, and methods relating to padded endcap devices. In some examples, an endcap for a roof rack crossbar may include a main body and a clamp configured to secure the main body to the crossbar. The main body may include a padding material that substantially covers a lower surface of the main body, and a channel to receive an end portion of the crossbar. An actuator of the clamp may be accessible from above the main body.

In some examples, a safety device for a roof-mounted vehicle cargo rack may include a main body and a clamp fixed to the main body that is configured to engage a crossbar of the roof-mounted vehicle cargo rack and thereby secure the main body to the crossbar. The main body may include a recessed channel in an upper surface, configured to receive at least a lower portion of an end of the crossbar when engaged by the clamp. A padding material may form a lower surface of the main body.

In some examples, a method of using a roof-mounted vehicle cargo rack may include providing a pair of padded endcaps for each crossbar of the rack, and receiving opposing end portions of each crossbar in recessed channels on top surfaces of a respective one of the pairs of padded endcaps. The method may further include securing a band of a clamp device of each padded endcap over an upper surface of the respective crossbar.

Features, functions, and advantages may be achieved independently in various examples of the present disclosure, or may be combined in yet other examples, further details of which can be seen with reference to the following description and drawings.

### BRIEF DESCRIPTION OF DRAWINGS

FIG. 1 is a top view of a roof rack on a vehicle, including illustrative padded endcaps in accordance with aspects of the present disclosure.

FIG. 2 is an isometric view of one of the endcaps of FIG. 1.

FIG. 3 is a side view of the endcap of FIG. 2, secured to a crossbar of the roof rack of FIG. 1.

FIG. 4 is an outer end view of the crossbar and endcap of FIG. 3.

FIG. 5 is an outer end view of another illustrative endcap secured to a square crossbar.

FIG. 6 is an outer end view of another illustrative endcap secured to an oval crossbar.

FIG. 7 is a schematic depiction of a main body portion of an illustrative padded endcap having a universal crossbar channel, and an aerodynamic crossbar.

FIG. 8 is a schematic depiction of the crossbar of FIG. 7 received by the universal crossbar channel of the endcap of FIG. 7.

FIG. 9 is a side view of an illustrative sleeve style padded endcap secured to a crossbar.

FIG. 10 is a is a flow chart depicting steps of an illustrative method for safely using a vehicle rooftop rack, according to the present teachings.

### DETAILED DESCRIPTION OF THE INVENTION

Various aspects and examples of a vehicle roof rack crossbar endcap including protective padding, as well as related methods, are described below and illustrated in the associated drawings. Unless otherwise specified, an endcap in accordance with the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed examples. The following description of various examples is merely illustrative in nature and is in no way intended to limit the disclosure, its application, or uses. Additionally, the advantages provided by the examples described below are illustrative in nature and not all examples provide the same advantages or the same degree of advantages.

This Detailed Description includes the following sections, which follow immediately below: (1) Definitions; (2) Overview; (3) Examples, Components, and Alternatives; (4) Illustrative Combinations and Additional Examples; (5) Advantages, Features, and Benefits; and (6) Conclusion. The Examples, Components, and Alternatives section is further divided into subsections A-C, each of which is labeled accordingly.

### Definitions

The following definitions apply herein, unless otherwise indicated. Additionally, as used herein, like numerals refer to like parts.

“Substantially” means to be predominantly conforming to the particular dimension, range, shape, concept, or other aspect modified by the term, such that a feature or component need not conform exactly, so long as it is suitable for its intended purpose or function. For example, a “substantially cylindrical” object means that the object resembles a cylinder, but may have one or more deviations from a true cylinder.

“Approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of the specified value, insofar as such variations are appropriate to perform in the disclosure. It is to be understood that the value to which the modifier “approximately” refers is itself also specifically, and preferably, disclosed.

### Overview

In general, a padded endcap in accordance with the present teachings may include padding and a clamp to secure the endcap to a crossbar of an automobile roof rack system. The padded endcap may be configured for use on automobile roof rack systems, particularly systems in which the crossbars of the roof rack extend beyond the width of the automobile, thereby sticking out over the side edges of the automobile. The exposed crossbars may pose a risk to the occupants of the vehicle or other persons in the vicinity of the vehicle. For instance, an occupant may hit their head on the extending portion of one of the crossbars as they enter or exit the vehicle, or while moving in close proximity to the side of the vehicle. A padded endcap as describe herein may be configured to protect against head injuries by padding the roof rack crossbar ends, thereby reducing the injury potential associated with impacts between a person's head and a vehicle's unprotected, or un-padded, roof rack bars.

A main body of a padded endcap may be described as having inner and outer ends, front and back sides, and upper and lower surfaces. When secured to the crossbar, the inner end of the main body may be closest to the vehicle, and the outer end may be most distant from the vehicle. The front side may face in a forward or driving direction of the vehicle, and the back side may face in a rearward or reversing direction of the vehicle.

The padding may cover and/or comprise some or all of a main body portion of the endcap. For example, padding may cover a lower side of the main body portion and an outer end of the main body portion. In some examples, padding may additionally extend over one or both of the front and back sides of the main body. In some examples, the main body may consist of padding.

The padding may include at least a padding material. In some examples, the padding may further include a protective and/or decorative outer cover. In some examples, the padding may include a supportive backing and/or structural elements. The padding material may be configured to reduce impact forces between a person and the crossbar, if that person's head or other body part collides with the padded endcap, as compared to the same collision occurring with the exposed crossbar. The padding material may consist of a single material, may comprise a composite material, and/or may comprise layers and/or sections of a number of materials. For example, the padding material may include a ‘cushioning’ layer of a low durometer foam and a layer of impact absorbing viscoelastic material.

A channel, groove, passage, and/or recess may be included in the main body of the padded endcap, which conforms to the roof rack crossbar. The channel may be configured to provide a tight and secure fit between the padded endcap and the crossbar. In some examples, the channel may be recessed into the upper surface of the main body and/or open at the top to allow an upper portion of the crossbar to remain exposed. In addition to material savings, not covering the upper portion of the crossbar may allow easy access to an actuating mechanism of the clamp that connects the padded endcap to the roof rack crossbar.

In some examples, the channel may be partly or wholly interior to the main body of the endcap. In such examples, the main body may include a cut-out, gap, opening, or other means of access to the clamp actuator.

The channel may extend only part way into the main body of the padded endcap. For instance, the channel may extend from the inner end of the main body toward the outer end of the main body, but may not extend to the outer end.

Any effective clamp, clamping mechanism, fastener, and/or means of securing the padded endcap to a crossbar may be included. The clamp and configuration thereof may be dependent on the size, shape, and/or type of roof rack bar to which the device will be connected. For example, a clamp that utilizes a flexible strap or chord, a ratchet-type, and/or a hose-clamp-type mechanism may be used. A band clamp may be useful for an endcap configured for connection to a range of crossbar sizes and/or shapes.

Padded endcaps may be manufactured from materials that are generally weather-resistant and/or otherwise configured for extended outdoor use. For example the endcaps may be configured to withstand wind forces, caused naturally or caused by driving a vehicle to which they are attached at high speeds. Endcaps may additionally or alternatively be configured to resist a wide range of weather conditions, such as rain, snow, ice, sleet, excessive cold, excessive wind, heat, dryness, sun exposure, and/or other weather and atmospheric conditions that might be encountered by a vehicle, including in car washing facilities.

In some examples, a protective strap with a hook and loop fastener, may cover an upper and/or exposed portion of the clamp mechanism, to reduce exposure of the clamp mechanism to weather and environmental conditions as described above.

Padded endcaps may be of various sizes, depending on the type of crossbar ends being covered, and the volume of padding appropriate to protect a person, who happened to hit their head or other body part on the covered crossbar, from impact injury. Padded endcaps may also be of various lengths to accommodate various lengths of roof rack crossbars. For example, a ten-inch-long padded endcap may be used when a roof rack crossbar extends beyond the side of a vehicle by approximately 8-10 inches. For another example, a two-inch length may be appropriate when a crossbar extends 2 inches or less past the side of the vehicle.

In some examples, a padded endcap may be configured to further protect a person in the vicinity of a roof rack by attracting visual attention to alert the person to the presence of a crossbar. For example, a padded endcap may include bright coloring, highly reflective surfaces, and/or a retroreflective material.

A padded endcap may also be available in multiple color options, such as red, yellow, orange, white, green, blue, purple, grey, black, and/or a color combination for decorative purposes and/or in order to make the padded endcap more or less visible as desired.

### EXAMPLES, COMPONENTS, AND ALTERNATIVES

The following sections describe selected aspects of exemplary padded endcaps as well as related systems and/or methods. The examples in these sections are intended for illustration and should not be interpreted as limiting the entire scope of the present disclosure. Each section may include one or more distinct examples, and/or contextual or related information, function, and/or structure.

### A. Illustrative Endcap

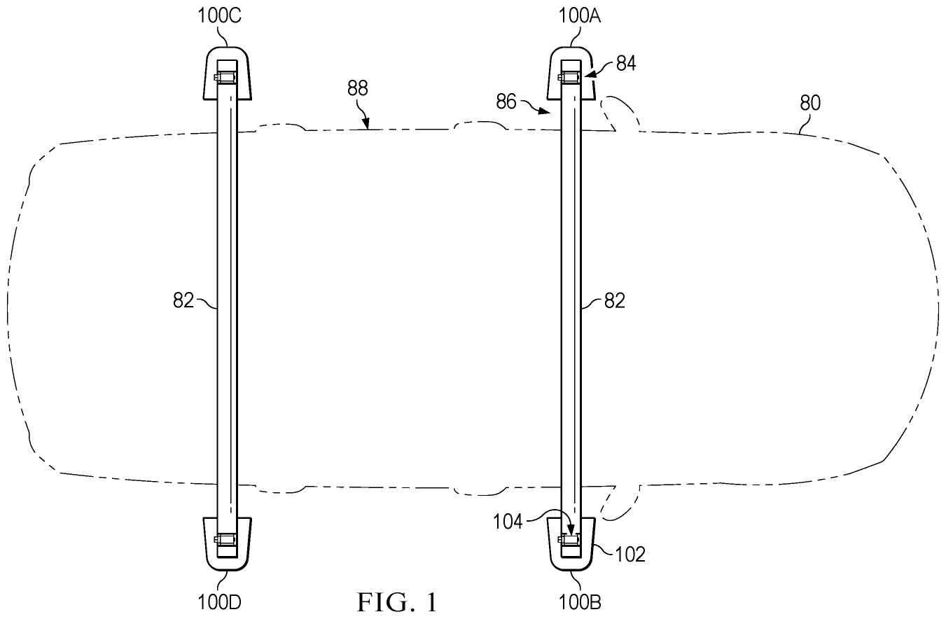

As shown in FIGS. 1-4, this section describes illustrative padded endcaps 100. Each endcap 100 is an example of a padded endcap as described above.

FIG. 1 depicts a top view of a vehicle 80 with an installed roof rack system including two roof rack bars or crossbars 82. Each crossbar 82 extends perpendicular to primary or forward-reverse axis of the vehicle. In the depicted example, crossbars 82 extend past lateral sides 88 of vehicle 80. Each crossbar therefore has an overhanging portion 86 at each of two opposing ends.

Four endcaps 100A, 100B, 100C, and 100D are installed on crossbars 82. A pair of endcaps is secured to each crossbar, with an endcap covering each end of each crossbar. Endcaps 100 are secured to overhanging portions 86 of the crossbars. End portions 84 of crossbars 82 are received in endcaps 100.

In the depicted example, end portions 84 are subsets of overhanging portions 86 and endcaps 100 do not cover all of the extension of the crossbars past vehicle sides 88. In some examples, end portions 84 may encompass or equal overhanging portions 86. In such examples, the endcaps may cover all extension of the crossbars past the vehicle sides. Such coverage may provide more comprehensive protection. A user of the roof rack system may select an endcap size according to the length of overhanging portions 86 for that specific combination of roof rack and vehicle, as well as a desired degree of coverage.

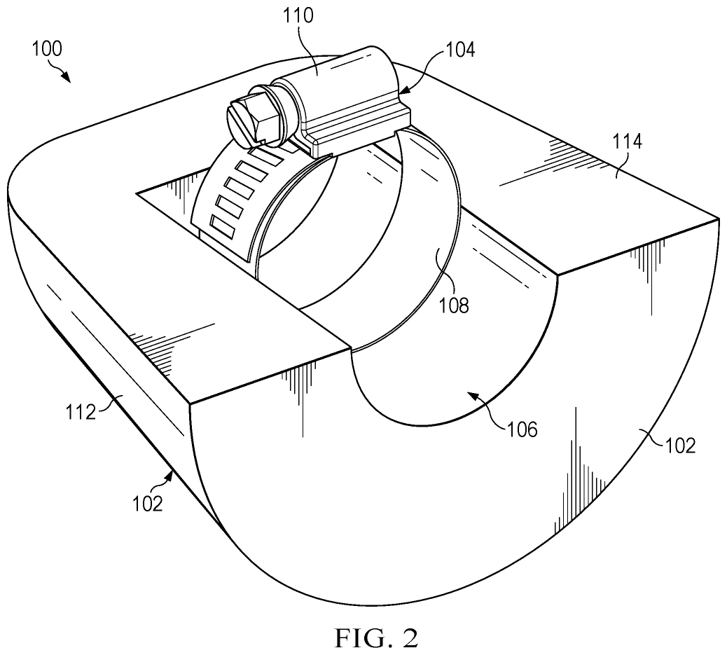

FIG. 2 shows a perspective view of one of endcaps 100. In the present example, endcaps 100A, 100B, 100C, 100D are matching and the following description may be understood to apply equally to all four endcaps. In some examples, a set of padded endcaps may include two or more differing sizes, designs, colors, or other variations of endcap.

As shown, endcap 100 includes a main body 102 and a clamp 104. Main body 102 is made up of padding 112 with facings 114, and includes a cut-out or channel 106, that provides a cradle for a received crossbar. Channel 106 may be described as recessed into main body 102, cut out from the main body, set into the main body and/or as open-topped. The open channel leaves an upper portion of the received crossbar outside of main body 102 and channel 106. In the depicted example, approximately an upper half of a received crossbar may remain exposed, while a lower half and an outermost end face of the crossbar may be covered by main body 102.

Such a channel design, leaving an upper portion of a crossbar exposed, may allow for access to an actuating mechanism 110 of clamp 104, so that endcap 100 can be easily attached and removed without main body 102 causing any hindrance. Given that a majority of impacts between a person's head, or other body part, and a roof rack crossbar will be impacts on the outer end or underside of the roof rack bar, padding on the top portion of the bar may be generally superfluous. However, in some examples, a padded endcap may include enclosing or surrounding padding.

Some roof rack crossbars include small, un-padded plugs or covers that are designed to enclose the end of the roof rack bars. Such covers may increase a diameter of the end portion of the crossbar, causing the end portion of the roof rack bar to be slightly larger in diameter than the remainder of the bar. In some examples, channel 106 may be shaped and/or sized to allow for the increase in bar diameter resulting from such a cover.

In the depicted example, clamp 104 includes a flexible band 108 and an actuating mechanism 110. The depicted clamp may be described as a band clamp or a hose clamp, and may be useful for securing endcap 100 to a range of crossbar shapes and sizes. The flexible band may conform to the shape of the crossbar, and actuating mechanism 110 may allow adjustment of the effective length of the band to accommodate variation in size. In general, clamp 104 of endcap 100 may include any effective clamping or securing mechanism.

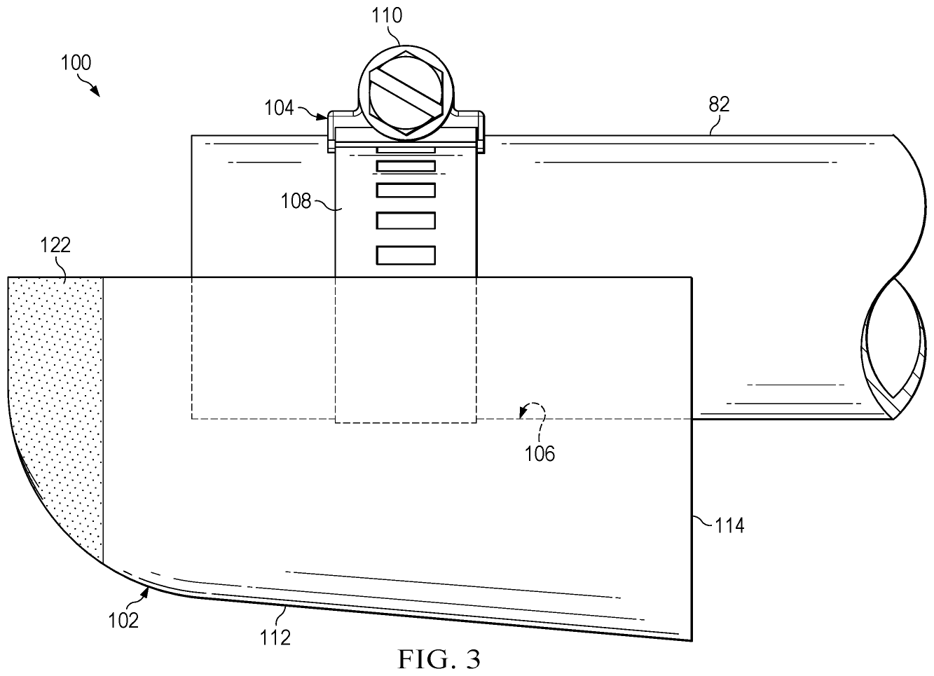

FIG. 3 is depicts a side view of endcap 100 secured to crossbar 82. As shown, padding 112 of main body 102 is a single material with a curved half-frustum shape. That is, the padding has an approximately semi-circular cross-sectional shape, and tapers from an inner end to an outer end. Facings 114 are fixed on an upper side and the inner end of the padding.

In some examples, main body 102 may include a rigid structure such as facings 114, and in some examples, the main body may consist entirely of padding material. Padding 112 may be referred to as covering surfaces of the main body and/or as defining or comprising surfaces of the main body.

In the present example, padding 112 is a medium density polyurethane foam and facings 114 are a rigid plastic. Facings 114 may provide structure to the endcap, and facilitate effective mounting of clamp 104 to the main body.

Padding 112 is configured to absorb a majority of any impact between a person and crossbar 82. Padding 112 may include any impact absorbing padding materials and/or combination thereof. The thickness, placement, and material of padding 112 may be selected interdependently to provide effective injury prevention. Preferably, the material or combination of materials and thickness thereof may be sufficient to absorb any impact forces which may result from collision with crossbar 82 in the course of normal activity in the vicinity of a vehicle.

For example, padding 112 may comprise a foam that is both sufficiently firm and sufficiently thick to indent by less than the foam's full height under impact by a person's head as the person straightens to a standing position. For another example, padding 112 may include an outer layer of a low density, high resilience foam and an inner layer of a high density elastomer.

The depicted shape of padding 112 of endcap 100 is one example of an effective arrangement of padding. Other shapes may be used to achieve specific design goals related to properties such as aerodynamics, style, and/or volume of padding. Padding 112 may cover at least a majority of a lower surface of main body 102 or of the end region of crossbar 82. Preferably, padding 112 may also cover the front and back sides of the main body or end region of the crossbar.

For example, a thickness of padding 112 may vary between a lower surface of main body 102 and front and back sides of the main body. That is, higher speed impacts may be expected to occur mainly at the underside of the crossbar, as a person straightens up or exits the vehicle. Whereas impacts to the side of the bar, by a lifted arm or turned head e.g., may be expected at lower speed. Accordingly, thinner and/or less dense foam may be used along the front and back sides of endcap 100.

Main body 102 of endcap 100 further includes a visibility region 122, configured to attract visual attention. In the present example, the region covers portions of the outer end and front and back sides of the main body. In general, any effective placement and/or design may be used. For instance, the region may cover a majority of the front and back sides and/or may comprise a design such as diagonal stripes that extends across the front and back sides.

The visibility region may include bright colors, light sources, reflective materials, or any effective means of attracting visual attention to alert someone in the vicinity of the vehicle to the location of the endcap and the end of the crossbar. For example, the region may include a design of warning colors such as bright red and/or yellow. For another example, the region may include a solar-charged ‘glow-in-the-dark’ or phosphorescent material. For another example, the region may include a shiny or retroreflective material.

Visibility region 122 may include a material or materials permanently fixed to padding 112 such as by adhesive or sewing, may be removably attached to the padding such as by a hook and loop fastener, may be printed onto the padding, and/or may be included in main body 102 in any effective manner.

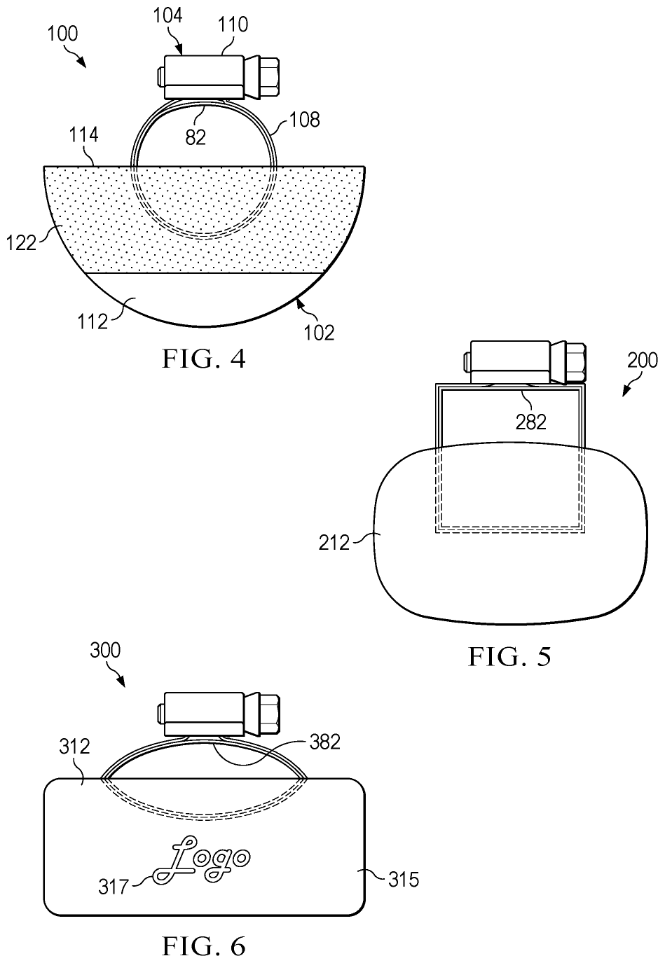

As shown in FIG. 4, crossbar 82 has a circular cross-sectional shape. Endcap 100 is shaped to conform to crossbar 82 for a secure attachment to the crossbar. Specifically, channel 106 is semi-circular (as also shown in FIG. 2). Padding 112 is also approximately semi-circular in cross-section, as the padding is approximately consistent in thickness. As described below with reference to FIGS. 5-8, a padded endcap may be configured to fit any specific crossbar shape, or may include a universal channel feature to allow connection to a variety of crossbar shapes. Padding 112 may correspond to the shape of the crossbar or may differ in shape.

### B. Illustrative Alternative Endcaps

As shown in FIGS. 5-9, this section describes additional illustrative padded endcaps 200, 300, 400, and 500. Each of the depicted endcaps is an example of a padded endcap as described above.

FIGS. 5 and 6 show end views of endcaps 200 and 300, each secured to a crossbar. Each endcap is configured to engage a specific shape of crossbar, endcap 200 to engage square crossbar 282 and endcap 300 to engage ‘ovalesque’ or almond-shaped crossbar 382. A channel of each endcap may be shaped to closely conform to the received crossbar. Padding 212 of endcap 200 has a rounded, but approximately square or squircle cross-sectional shape. Padding 312 of endcap 300 has an approximately rectangular cross-sectional shape.

Endcap 300 further includes a planar outer end surface 315. As shown in FIG. 6, such a surface allows the inclusion of a brand logo 317. In some examples, the front and/or back side of the end cap may additionally or alternatively include one or more planar surfaces appropriate for display of a logo or other graphic. Logo 317 may be applied similarly to visibility region 122 of endcap 100, described above. In some examples, the logo may also function to provide improved visibility of the endcap and crossbar end, by use of bright colors, phosphorescence, and/or reflective materials.

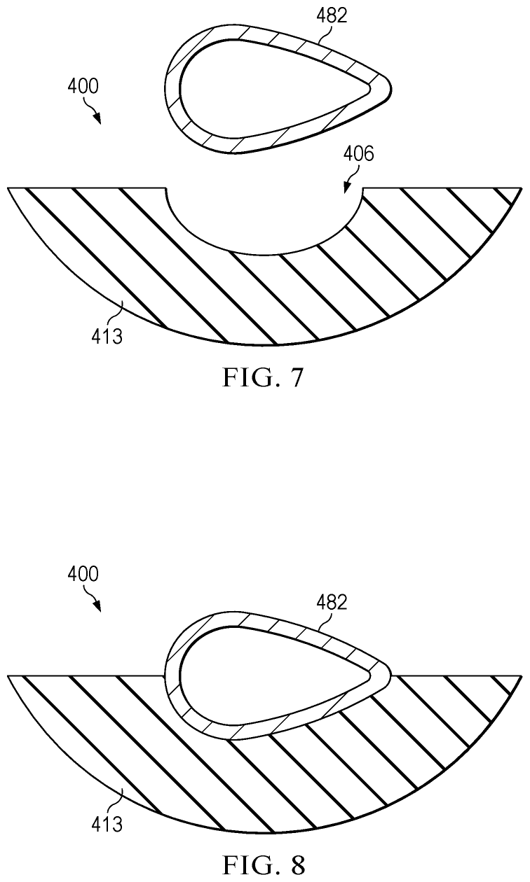

FIGS. 7 and 8 are schematic depictions of an endcap 400, which includes a ‘universal’ channel where one size of channel fits a majority of roof rack bar shapes and sizes. A main body of the endcap includes a resilient, elastically deformable material 413 which defines channel 406. A clamping mechanism and other elements of endcap 400 are omitted for clarity.

In the depicted example, channel 406 is approximately semi-circular in cross-section, but the channel may have any cross-sectional shape generally similar to a majority of cross-bar shapes. Also depicted in FIGS. 7 and 8 is an asymmetrical, approximately aerodynamically shaped crossbar 482. As seen in FIG. 7, channel 406 does not match crossbar 482 in shape. However, as crossbar 482 is received into channel 406 as shown in FIG. 8, material 413 deforms to closely match the shape of crossbar 482 and provide a secure seat for the crossbar.

In other words, material 413 compresses around the end of the bar thereby eliminating an actual channel, and instead relying on the material itself to mold, or shape, itself around the bar. A material such as foam rubber may allow the top portion of the padded end cap to compress onto and around the bar, forming a tight seal between the top portion of the padded endcap and the bar. In this way, the top of the padded endcap may be able to mold around any bar shape without needing a channel matching the specific bar shape.

In some examples, endcap 400 may include material 413 and additional or alternative padding material. In some examples, material 413 may also function as a padding material.

FIG. 9 shows a side view of an endcap 500. In endcap 500, a form-fitting sleeve 520 is incorporated into a padded endcap as described with reference to FIGS. 1-4, with a universal channel defined by a compressible material as discussed with reference to FIGS. 7-8. Sleeve 520 may therefore fit over any shape of crossbar, and the sleeve may help to hold the padded endcap onto the roof rack cross bar.

### C. Illustrative Method

This section describes steps of an illustrative method 600 for safely using a vehicle rooftop rack. Aspects of endcaps, rooftop racks, and crossbars as described above may be utilized in the method steps described below. Where appropriate, reference may be made to components and systems that may be used in carrying out each step. These references are for illustration, and are not intended to limit the possible ways of carrying out any particular step of the method.

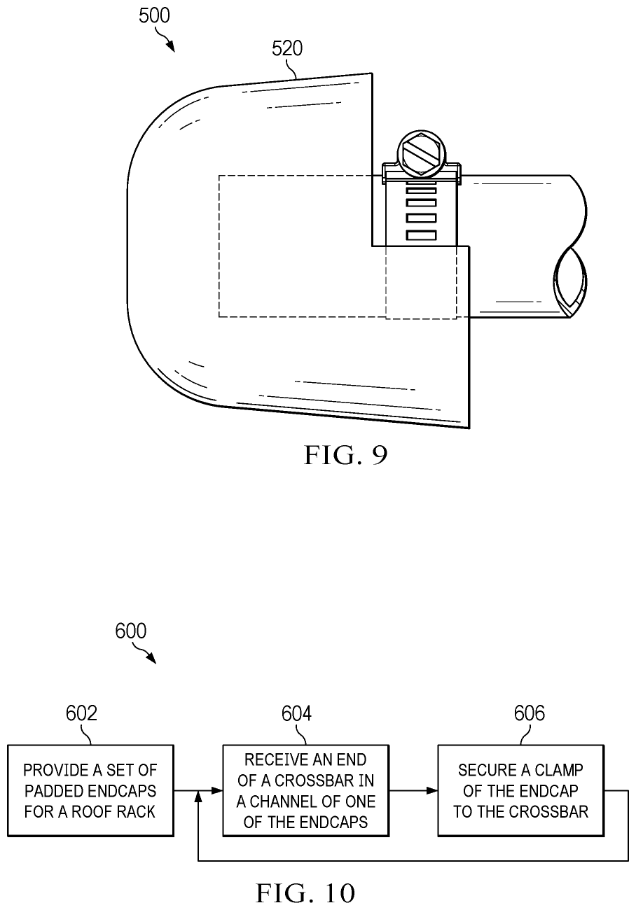

FIG. 10 is a flowchart illustrating steps performed in an illustrative method, and may not recite the complete process or all steps of the method. Although various steps of method 600 are described below and depicted in FIG. 10, the steps need not necessarily all be performed, and in some cases may be performed simultaneously or in a different order than the order shown.

At step 602, the method includes providing a set of padded endcaps for a roof rack. The endcaps provided may include any of the endcaps described above and/or any padded endcap including features as described herein. The padded endcaps may be a matching set of identical devices, or may include endcaps of more than one design. The set of padded endcaps may include any number of pairs of endcaps, where the number of pairs may correspond to a number of bars or crossbars in the roof rack.

In some examples, the provided set of endcaps may be used on only a portion of the roof rack. In such examples, endcaps may be individual and not pairs and/or may include fewer endcaps than the roof rack has crossbar ends. For instance, a user may install padded endcaps only on a driver-side of a vehicle or only on a rear section of the roof rack, where crossbars of the roof rack have a greater extension past a lateral side of the vehicle.

In some examples, the provided endcaps may be configured specifically for crossbars of the roof rack and/or crossbars of a shape or size range including crossbars of the roof rack. In some examples, the endcaps may be configured for use with a broad range of crossbar types.

Each endcap may include a channel to receive an end portion of a crossbar of the roof rack, and a clamp to secure the endcap to the crossbar. Each endcap may be installed on an end of a crossbar of the roof rack, according to steps 604-606. That is, steps 604 and 606 may be repeated for each endcap and a corresponding end of one of the crossbars.

Step 604 includes receiving an end of a crossbar in a channel of one of the endcaps. The channel may be open on top, or may be enclosed. A user may press the endcaps up onto the crossbar from below and/or may slide the endcap onto the end of the crossbar in a direction parallel to the primary extent of the crossbar.

In some examples, the channel may be defined by a rigid material. In such examples, the channel may closely match the shape of the crossbar. In some examples, the channel may be defined by an elastically deformable material. In such examples, step 604 may include deforming the material to closely conform to the crossbar. For instance, the crossbar may be pressed into the channel by a user and/or the channel may be small enough that sliding the endcap onto the crossbar presses the crossbar against sides of the channel.

Step 606 includes securing a clamp of the endcap to the crossbar. In some examples, the clamp or some portion of the clamp may be positioned in the channel, such that the end of the crossbar is received by the clamp as part of step 604. In such examples, step 606 may include tightening the clamp around the crossbar. For instance, a band of a band clamp may loosely surround the channel, and any crossbar received in the channel. The band may then be tightened around the crossbar.

An actuator or mechanism of the clamp may be accessed from above the endcap, as part of step 606 and/or to adjust or release the clamp after installation of the endcap. That is, a user may be able to manipulate the actuator manually or with tools while the end of the crossbar is received in the channel of the endcap.

On completing method 600, a user may leave the endcaps installed on the roof rack indefinitely. While installed, the endcaps may protect users of the roof rack and/or vehicle from injury. The endcaps may be designed to withstand typical weather conditions and remain securely attached during use of a vehicle, such as driving or cleaning by an automated car wash. In some examples, the endcaps may be left in place on the crossbars when the roof rack is removed from a vehicle.

In some examples, steps 604-606 may be reversed to remove the endcaps from the roof rack, for cleaning or storage. In such examples, steps 604-606 may be repeated for re-installation of the endcaps.

### Illustrative Combinations and Additional Examples

This section describes additional aspects and features of endcaps and related systems and methods, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. An endcap for a roof rack crossbar, comprising:

a main body including a padding material and a channel to receive an end portion of the crossbar; and

a clamp configured to secure the main body to the crossbar;

wherein an actuator of the clamp is accessible from above the main body, and the padding material substantially covers a lower surface of the main body.

A1. The endcap of paragraph A0, wherein the main body surrounds only a lower half of the end portion of the crossbar.

A2. The endcap of paragraph A0 or A1, wherein the channel of the main body receives between approximately 2 and 10 inches of the crossbar.

A3. The endcap of any of paragraphs A0-A2, wherein the padding material of the main body is impact absorbing.

A4. The endcap of paragraph A3, wherein the padding material comprises one or more of a foam and an elastomer.

A5. The endcap of paragraph A3, wherein the padding material is sufficient to absorb impacts associated with a person colliding with the crossbar during routine use of a vehicle and attached roof rack.

A6. The endcap of any of paragraphs A0-A5, wherein the clamp is a band clamp, and the clamp is partially received in the channel of the main body.

A7. The endcap of any of paragraphs A0-A6, wherein the channel is shaped to conform to a specific crossbar cross-sectional shape.

A8. The endcap of any of paragraphs A0-A7, wherein the channel is defined by an elastically deformable material, configured to deform to match a cross-sectional shape of the end portion of the crossbar.

A9. The endcap of any of paragraphs A0-A8, wherein the elastically deformable material and the padding material comprise the same material.

A10. The endcap of any of paragraphs A0-A9, wherein a surface of the main body is planar, and includes a brand logo.

A11. The endcap of any of paragraphs A0-A10, wherein the main body is configured to attract visual attention.

A12. The endcap of paragraph A11, wherein at least a portion of the main body is at least one of (a) a bright yellow or red color, (b) retroreflective, or (c) phosphorescent.

B0. A safety device for a roof-mounted vehicle cargo rack, comprising:

a main body, including a recessed channel in an upper surface and a padding material forming a lower surface; and

a clamp fixed to the main body and configured to engage a crossbar of the roof-mounted vehicle cargo rack and thereby secure the main body to the crossbar;

wherein the recessed channel of the main body is configured to receive at least a lower portion of an end of the crossbar when engaged by the clamp.

B1. The safety device of paragraph B0, wherein the recessed channel is configured to receive only the lower portion of the end of the crossbar.

B2. The safety device of paragraph B0 or B1, wherein the padding material comprises one or more of a foam and an elastomer.

B3. The safety device of any of paragraphs B0-B2, wherein the recessed channel is defined by an elastically deformable material, configured to deform to match a cross-sectional shape of the end of the crossbar.

C0. A method of using a roof-mounted vehicle cargo rack, comprising:

providing a pair of padded endcaps for each crossbar of the rack;

receiving opposing end portions of each crossbar in recessed channels on top surfaces of a respective one of the pairs of padded endcaps; and

securing a band of a clamp device of each padded endcap over an upper surface of the respective crossbar.

C1. The method of paragraph C0, wherein receiving the end portion of the crossbar in the recessed channel includes elastically deforming a material defining the channel to conform to a cross-sectional shape of the crossbar.

C2. The method of paragraph C0, including accessing an actuator of each clamp device from above the endcap, while the clamp device is secured to the respective crossbar.

D0. A padded endcap device to cover the end portion of a vehicle's roof rack bar(s) and to be secured to the roof rack bar(s).

D1. A padded portion of the endcap device of paragraph D0, of sufficient size and padding content to cover the ends of a vehicle's roof rack bar(s) and provide padded protection from head and bar impacts which reduces, and in many cases, eliminates, the risks associated with receiving an injury from a person hitting their head, or other body part, on a roof rack bar end that is not so covered.

D2. A channel formed within the padded portion of the device of paragraph D1, which channel conforms with the general shape and size of the roof rack bar end being covered by the padded portion of the device, and which channel only extends part-way into the padded portion of the device, so that a portion of the padding extends outward from the end of the channel ensuring padding over the direct end portion of the roof rack bar(s), and so that the upper portion of the device may be accessible for clamp mechanism manipulation as is necessary when attaching and removing the padded endcap device.

D3. A clamping mechanism that is incorporated into the padded portion of the device of paragraph D1 or D2, which clamping mechanism securely holds the device to the roof rack bar's end(s), and which clamping device can be of any type or configuration, with the main features being that the clamping mechanism is able to securely hold the device to the roof rack bar, that the clamping mechanism be functional when utilized in combination with whatever roof rack bar the device is being secured to, and that it be designed to facilitate the ease of attachment and removal from the roof rack bar.

D4. A clamping mechanism cover piece available to easily wrap the clamping mechanism of paragraph D3, to minimize exposure of the clamping mechanism to weather and environmental elements. Said cover could be integrated into the padded endcap device utilizing Velcro, or Velcro-like materials, to secure any loose portions of the cover piece, such as a wrap style covering piece, whereby one end of the wrap style covering piece is permanently affixed to the device while the other end of the wrap style covering piece incorporates a Velcro, or Velcro-like, securing mechanism. This type of wrap style covering piece may allow it to be easily secured into place, and easily removed in the event of a need to remove the entire padded endcap device.

D5. A padded portion of the device of any of paragraphs D0-D4, that only covers the lower half of the end of the roof rack bar which allows the clamping mechanism to be accessed easily.

E0. A padded endcap device that is manufactured out of materials that provide padding, and that are generally weather-resistant, able to withstand the forces of wind, caused naturally or caused by driving the vehicle to which they are attached at high speeds, and in all types of weather conditions, be they rain, snow, ice, sleet, excessive cold, excessive wind, heat, dryness, sun exposure, and all other weather and atmospheric condition types and conditions that might be encountered by a vehicle during any given drive, including expected trips through car washing facilities, or during hand-washing.

F0. A padded endcap device that is of various lengths to cover exposed roof rack bar ends that extend out anywhere from one or two inches to upwards of six, eight, or ten inches, or more, depending on the length of bar that is desired to be covered. With a relatively long cover, additional or modified clamping mechanisms may be included to ensure the secure attachment of the longer padded endcap device to the roof rack bar(s).

G0. A padded endcap device that has sufficient padding surrounding the bar end, and portions thereof, such that the padding protects against a person hitting their head on the roof rack bar.

H0. A padded endcap device that securely attaches to a roof rack bar at, or near, the roof rack bar's end(s), thus covering the roof rack bar end(s), and portions thereof, with padding that is secured to the roof rack bar.

J0. A padded endcap device that attaches to a vehicle's roof rack bar(s) that is aerodynamic, and made of materials that will assist in the device being aerodynamic.

### Advantages, Features, and Benefits

The different examples of the padded endcaps described herein provide several advantages over known solutions for improving roof rack safety. For example, illustrative examples described herein reduce the risk of injury if a person's head impacts with the roof rack bar.

Additionally, and among other benefits, illustrative examples described herein make the ends of the roof rack bars more noticeable to persons near the vehicle, thereby making their position and existence more easily recognized by persons near the vehicle, allowing those persons to avoid impact with the bars.

Additionally, and among other benefits, illustrative examples described herein stay secured to a vehicle when the vehicle is traveling at high speeds, when the vehicle is traveling through inclement weather events such as rain, hail, ice, snow, high wind, and the like, as well as when the vehicle is being washed in an automated vehicle washing establishment, or hand washed.

Additionally, and among other benefits, illustrative examples described herein allow easy access to the mechanism that clamps the padded endcap to the vehicle roof rack bars so that the padded endcaps can be easily and conveniently attached and removed as desired.

Additionally, and among other benefits, illustrative examples described herein elastically deform in response to pressure from a roof rack bar, in order to conform to the shape of that bar, creating a secure coupling between any roof rack bar and the padded endcap device.

No known system or device can perform these functions, particularly for the full variety of roof rack bar shapes and sizes, from circular or square to almond or aerodynamically shaped bars. Thus, the illustrative examples described herein are particularly useful for a vehicle owner to attach to an existing roof rack on their vehicle. However, not all examples described herein provide the same advantages or the same degree of advantage.

### Conclusion

The disclosure set forth above may encompass multiple distinct examples with independent utility. Although each of these has been disclosed in its preferred form(s), the specific examples thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. An endcap for a roof rack crossbar, comprising:
a main body including a padding material and a channel to receive an end portion of the crossbar; and
a clamp configured to secure the main body to the crossbar;
wherein an actuator of the clamp is accessible from above the main body, and the padding material substantially covers a lower surface of the main body.

2. The endcap of claim 1, wherein the main body surrounds only a lower half of the end portion of the crossbar.

3. The endcap of claim 1, wherein the channel of the main body receives between approximately 2 and 10 inches of the crossbar.

4. The endcap of claim 1, wherein the padding material of the main body is impact absorbing.

5. The endcap of claim 4, wherein the padding material comprises one or more of a foam and an elastomer.

6. The endcap of claim 4, wherein the padding material is sufficient to absorb impacts associated with a person colliding with the crossbar during routine use of a vehicle and attached roof rack.

7. The endcap of claim 1, wherein the clamp is a band clamp, and the clamp is partially received in the channel of the main body.

8. The endcap of claim 1, wherein the channel is shaped to conform to a specific crossbar cross-sectional shape.

9. The endcap of claim 1, wherein the channel is defined by an elastically deformable material, configured to deform to match a cross-sectional shape of the end portion of the crossbar.

10. The endcap of claim 9, wherein the elastically deformable material and the padding material comprise the same material.

11. The endcap of claim 1, wherein a surface of the main body is planar, and includes a brand logo.

12. The endcap of claim 1, wherein the main body is configured to attract visual attention.

13. The endcap of claim 12, wherein at least a portion of the main body is at least one of (a) a bright yellow or red color, (b) retroreflective, or (c) phosphorescent.

14. A safety device for a roof-mounted vehicle cargo rack, comprising:
a main body, including a recessed channel in an upper surface and a padding material forming a lower surface; and
a clamp fixed to the main body and configured to engage a crossbar of the roof-mounted vehicle cargo rack and thereby secure the main body to the crossbar;
wherein the recessed channel of the main body is configured to receive at least a lower portion of an end of the crossbar when engaged by the clamp.

15. The safety device of claim 14, wherein the recessed channel is configured to receive only the lower portion of the end of the crossbar.

16. The safety device of claim 14, wherein the padding material comprises one or more of a foam and an elastomer.

17. The safety device of claim 14, wherein the recessed channel is defined by an elastically deformable material, configured to deform to match a cross-sectional shape of the end of the crossbar.

18. A method of using a roof-mounted vehicle cargo rack, comprising:
providing a pair of padded endcaps for each crossbar of the rack;
receiving opposing end portions of each crossbar in recessed channels on top surfaces of a respective one of the pairs of padded endcaps; and
securing a band of a clamp device of each padded endcap over an upper surface of the respective crossbar.

19. The method of claim 18, wherein receiving the end portion of the crossbar in the recessed channel includes elastically deforming a material defining the channel to conform to a cross-sectional shape of the crossbar.

20. The method of claim 18, including accessing an actuator of each clamp device from above the endcap, while the clamp device is secured to the respective crossbar.
